(19) United States
(12) Patent Application Publication
(10) Pub. No.: US 2004/0036759 A1
(43) Pub. Date: Feb. 26, 2004

(54) Optical fixing unit for thermosensitive recording paper

(75) Inventors: Nobuo Katsuma, Saitama (JP); Kenichi Inatsuki, Saitama (JP); Akihiko Machida, Saitama (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/641,071

(22) Filed: Aug. 15, 2003

(30) Foreign Application Priority Data
Aug. 21, 2002 (JP) 2002-240884

(51) Int. Cl. B41J 2/315

(52) U.S. Cl. 347/212

(57) ABSTRACT

A xenon lamp is used as a light source of an optical fixing unit. A discharge stop switch for compulsorily stopping discharge of the xenon lump is provided. Further, a timer circuit for measuring a discharge time of the xenon lamp is provided. The timer circuit is activated after a predetermined time, which is set in advance, to stop the discharge of the xenon lamp. The inside of a printer is prevented from becoming a high-temperature state caused by ingredients of an infrared region of the xenon lamp. It is possible to improve efficiency of optical fixation.

### BACKGROUND OF THE INVENTION

1. Field of the Invention

The present invention relates to an optical fixing unit for performing optical fixation on a color thermosensitive recording paper in which thermosensitive coloring layers are formed on a base.

2. Description of the Related Art

A color thermal printer for forming a color image is known. The color image is formed by performing thermal recording on a color thermosensitive recording paper in which thermosensitive coloring layers of yellow, magenta and cyan are formed on a base. In the color thermal printer, optical fixation is performed by radiating electromagnetic rays, for example ultraviolet rays, to the color thermosensitive recording paper just after thermal recording, in order to prevent the respective thermosensitive coloring layers of yellow and magenta from coloring again after thermal recording. The electromagnetic rays have wavelength regions particular to the respective thermosensitive coloring layers.

An optical fixing unit comprises a yellow-fixing lamp and a magenta-fixing lamp. The yellow-fixing lamp optically fixes the yellow thermosensitive coloring layer by radiating near ultraviolet rays whose luminous peak is 420 nm. The magenta-fixing lamp optically fixes the magenta thermosensitive coloring layer by radiating ultra violet rays whose luminous peak is 365 nm. In a conventional color thermal printer, a mercury fluorescent lamp of a straight-tube type is used as a fixing lamp. As to the mercury fluorescent lamp, however, an irradiation amount of ultraviolet rays reduces due to a change with the passage of time so that luminous efficiency deteriorates. In order to obtain the irradiation amount of the ultraviolet rays necessary for optical fixation, it is required to lower a conveyance speed of the recording paper. Thus, there arises a problem in that a fixing time lengthens.

In order to solve the above problem, is proposed an optical fixing unit in which a flash discharge tube to be used in a flash device of a camera (disclosed in Japanese Patent Laid-Open Publication No. 62-34139) is employed as a light source. The flash discharge tube is a xenon flash lamp, for instance. The xenon flash lamp has spectral characteristics being flat between wavelengths of 350 nm and 450 nm such as shown by a solid line in FIG. 8. In virtue of this, the xenon flash lamp may be used as a fixing light source for both of the yellow and magenta thermosensitive coloring layers.

The mercury fluorescent lamp uses the mercury having a liquid phase at a normal temperature, and the irradiation amount greatly depends on the temperature. Moreover, sufficient irradiation strength can not be obtained before a tube wall is warmed. Thus, there is a disadvantage that it takes a long time from lighting to reach a predetermined irradiation amount. By contrast, in the xenon flash lamp, the xenon gas has a gaseous phase at the normal temperature so that the irradiation amount seldom depends on the temperature. The xenon flash lamp has an advantage that the desired irradiation amount can be immediately obtained. Further, by using the xenon flash lamp, it is possible without slowing the conveyance speed of the recording paper to obtain the irradiation amount of the ultraviolet rays, which is necessary for the optical fixation, through a life of the lamp.

Such as shown in FIG. 8, spectral distribution of the xenon flash lamp is widely distributed not only throughout the wavelengths of 350 nm to 450 nm, which are necessary for the optical fixation, but also throughout a visible-ray region and an infrared region. Due to this, electric power supplied to the lamp is inefficiently converted to energy available for the optical fixation, and a large percent thereof is converted into heating energy caused by ingredient of the infrared region. As a result, the inside of the printer becomes high temperature. In order to solve this problem, it is necessary to provide a cooling device in the printer or to secure a space for heat radiation. In any event, the printer is likely to be enlarged.

### SUMMARY OF THE INVENTION

In view of the foregoing, it is a primary object of the present invention to provide an optical fixing unit in which efficiency for optical fixation is improved by controlling consumption of energy unavailable for the optical fixation.

It is a second object of the present invention to provide an optical fixing unit contributing to downsizing of the unit.

In order to achieve the above and other objects, the optical fixing unit according to the present invention comprises a flash discharge tube for generating electromagnetic rays, a discharge stop member for compulsorily stopping an electric discharge of the flash discharge tube, and a control member for actuating the discharge stop member on the basis of irradiation conditions of the electromagnetic rays.

The optical fixing unit optically fixes a thermosensitive recording paper just after printing has been performed thereon. The thermosensitive recording paper includes at least two thermosensitive coloring layers formed on a base. The respective coloring layers except the lowermost one possess characteristics so as to be optically fixed by the electromagnetic rays having certain wavelength regions. The flash discharge tube generates the electromagnetic rays having the wavelength regions being capable of optically fixing at least two of the thermosensitive coloring layers.

In a preferred embodiment, the control member comprises a timer circuit for measuring a discharge time of the flash discharge tube. The discharge stop member is actuated when a predetermined discharge time has passed. Alternatively, the control member may include a first illuminance sensor and a second illuminance sensor. The first illuminance sensor measures an irradiation amount of the electromagnetic rays relative to the wavelength region, which is unavailable for the optical fixation. The second illuminance sensor measures an irradiation amount of the electromagnetic rays relative to the whole wavelength regions. Further, the control member may include a divider for obtaining a ratio of the above two irradiation amounts, and a comparator for comparing the obtained ration with a predetermined value.

According to the optical fixing unit of the present invention, it is possible to improve efficiency of the optical fixation. Moreover, it is possible to contribute to downsizing of the unit.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a structure of a color thermal printer according to a first embodiment of the present invention;

FIG. 2 is a block diagram showing an electrical structure of the color thermal printer shown in FIG. 1;

FIG. 3 is a graph showing a relationship between discharge times of a xenon lamp and irradiation strengths thereof, with respect to each wavelength region;

FIG. 4 is a schematic illustration showing a structure of a color thermal printer according to a second embodiment of the present invention;

FIG. 5 is a block diagram showing an electrical structure of the color thermal printer shown in FIG. 4;

FIG. 6 is a schematic illustration showing another embodiment of an optical fixing unit;

FIG. 7 is a schematic illustration showing the other embodiment of the optical fixing unit; and

FIG. 8 is a graph showing spectral characteristics of the xenon lamp.

### DETAILED DESCRIPTION OF THE PREFERRED EMBODIMENT(S)

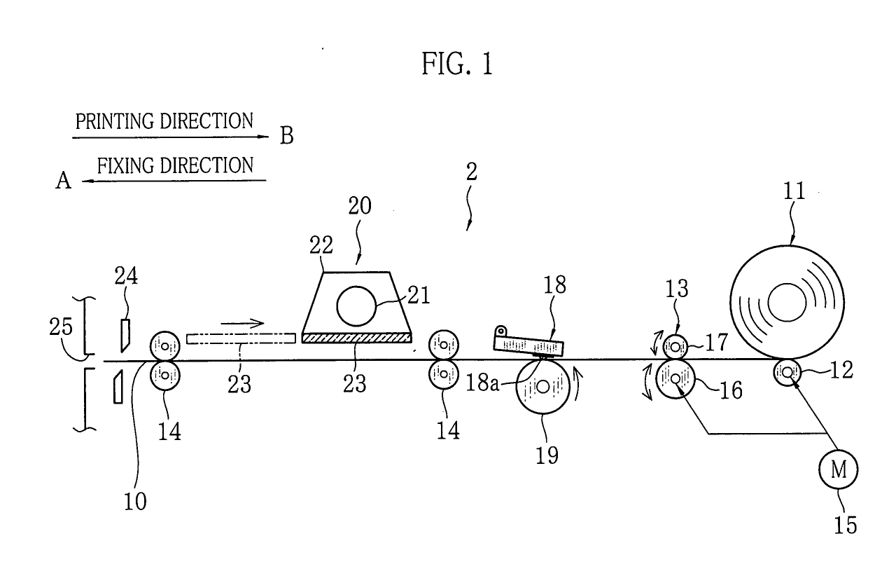

FIG. 1 is a schematic illustration showing a structure of a color thermal printer according to a first embodiment of the present invention. The color thermal printer 2 uses a strip of a color thermosensitive recording paper (hereinafter, simply called as recording paper) 10 as a thermosensitive recording medium. The recording paper 10 is set to the color thermal printer 2 in a state of a recording-paper roll 11 wound in a roll form. The recording-paper roll 11 is rotated by a feed roller 12 abutting on a periphery thereof to advance and rewind the recording paper 10.

A conveyor roller pair 13 is disposed near the recording-paper roll 11 to catch and convey the recording paper 10. Further, plural guide rollers 14 are disposed along a conveyance passageway of the recording paper 10. The conveyor roller pair 13 comprises a capstan roller 16 and a pinch roller 17. The capstan roller 16 is rotated by a motor 15. The pinch roller 17 is pressed against the capstan roller 16. The conveyor roller pair 13 reciprocates the recording paper 10 in directions of a fixing direction A and a printing direction B.

As well known, the recording paper 10 includes thermosensitive coloring layers of cyan, magenta and yellow, which are formed on a base in order. The yellow thermosensitive coloring layer is the uppermost layer and has the highest thermal sensitivity so as to color in yellow with small thermal energy. The cyan thermosensitive coloring layer is the lowermost layer and has the lowest thermal sensitivity so as to color in cyan with great thermal energy. The yellow thermosensitive coloring layer loses coloring ability when near ultraviolet rays of 420 nm are applied. The magenta thermosensitive coloring layer colors in magenta with thermal energy intermediately ranked between those of the yellow and cyan thermosensitive coloring layers. The magenta thermosensitive coloring layer loses coloring ability when ultraviolet rays of 365 nm are applied.

A thermal head 18 and a platen roller 19 are disposed at a downstream side of the conveyor roller pair 13 in the fixing direction A so as to be positioned at both sides of the conveyance passageway of the recording paper 10. A face of the thermal head 18 confronting the recording paper 10 is provided with a heating-element array 18a formed in a line shape extending in a direction perpendicular to the fixing direction A of the recording paper 10.

The platen roller 19 is disposed under the conveyance passageway and is positioned so as to confront the heating-element array 18a. The platen roller 19 is movable in a vertical direction and is urged by a spring, which is not shown, in a pressing direction relative to the thermal head 18.

The thermal head 18 is pressed against the recording paper 10 conveyed by the conveyor roller pair 13 in the printing direction B to color the respective coloring layers with the heating-element array 18a heated up to a predetermined temperature. The platen roller 19 is rotated in association with the conveyance of the recording paper 10 to facilitate the sliding contact of the recording paper 10 and the heating-element array 18a.

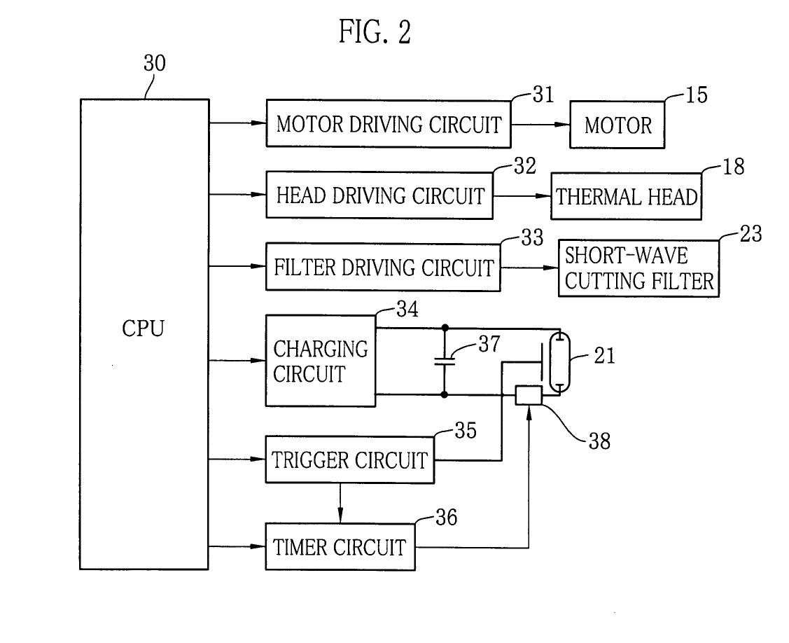

An optical fixing unit 20 is disposed at a downstream side of the thermal head 18 in the fixing direction A. The optical fixing unit 20 comprises a xenon flash lamp (hereinafter abbreviated as Xe-lamp) 21, a reflector 22 and a short-wave cutting filter 23. The Xe-lamp 21 is a flash discharge tube comprising a transparent glass tube, in which xenon gas is filled, and electrodes provided at both ends of the glass tube. A high voltage is applied to the electrodes of the ends of the glass tube in response to a trigger signal outputted from a trigger circuit 35 (see FIG. 2). Electric charge stored in a discharge capacitor 37 (see FIG. 2) is discharged inside the glass tube to flash the Xe-lamp 21.

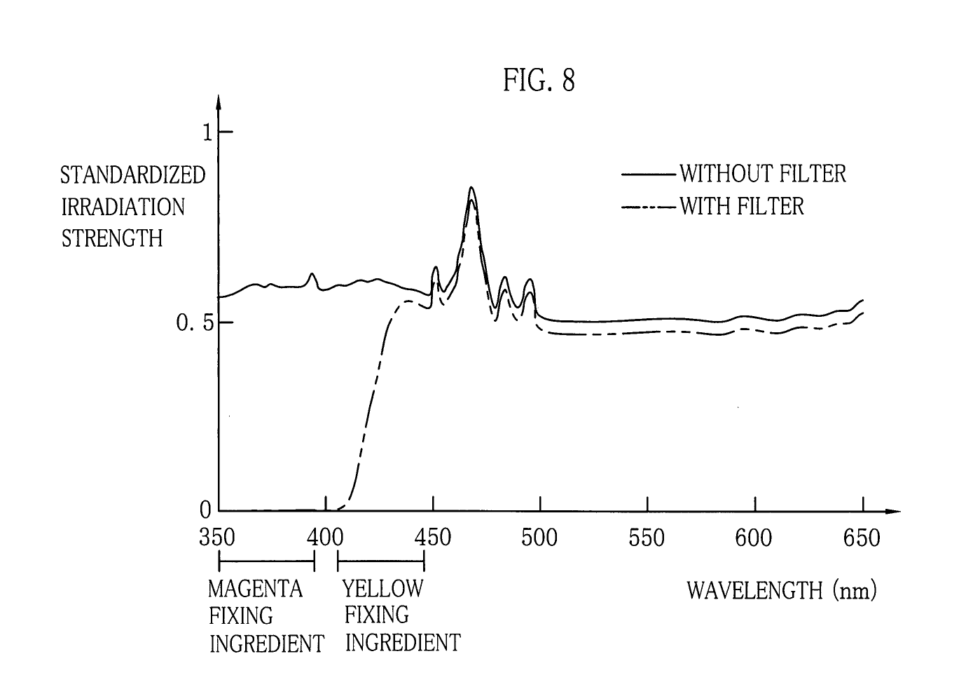

The reflector 22 reflects the ultraviolet rays radiated from the Xe-lamp 21, toward the recording paper 10. The short-wave cutting filter 23 is movable between an insertion position shown by a solid line and an evacuation position shown by a tow-dot line. The short-wave cutting filter 23 is inserted between the Xe-lamp 21 and the recording paper 10 while kept in the insertion position. In contrast, the short-wave cutting filter 23 is evacuated from the insertion position while kept in the evacuation position. When a yellow image is optically fixed, the short-wave cutting filter 23 is moved to the insertion position to cut magenta fixing ingredients Of the ultraviolet rays radiated from the Xe-lamp 21, such as shown by a two-dot line in FIG. 8. Meanwhile, when the magenta image is optically fixed, the short-wave cutting filter 23 is moved to the evacuation position. In virtue of this, when the yellow image is optically fixed, it is prevented to fix the magenta thermosensitive coloring layer for which recording is not yet performed.

At a downstream side of the optical fixing unit 20 in the fixing direction A, is disposed a cutter 24 for cutting the strip of the recording paper 10 at intervals of a recording area. A paper outlet 25 is formed at a downstream side of the cutter 24 in order to discharge the recording paper 10 cut into a sheet form.

In FIG. 2 showing an electrical structure of the color thermal printer 2, a CPU 30 totally controls an operation of the whole color thermal printer 2. A motor driving circuit 31, a head driving circuit 32, a filter driving circuit 33, a charging circuit 34, the trigger circuit 35 and a timer circuit 36 are connected to the CPU 30. The respective circuits 31 to 36 control the motor 15, the thermal head 18, the short-wave cutting filter 23 and the Xe-lamp 21 in response to control signals outputted from the CPU 30.

The charging circuit 34 is constituted of a power source, a transformer, a transistor and so forth, which are not shown, to charge the discharge capacitor 37 with the electric charge of an amount necessary for one-time optical fixation. The trigger circuit 35 generates the trigger signal in response to a flash instruction signal, which is outputted from the CPU 30, to apply the high voltage to the electrodes of both ends of the Xe-lamp 21. The electric charge stored in the discharge capacitor 37 is discharged inside the glass tube. Incidentally, the Xe-lamp 21 may be turned on plural times by repeating the charge-and-discharge operation of the discharge capacitor 37. Moreover, a number of the Xe-lamp 21 is not exclusive to one, but a plurality thereof may be arranged side by side.

A discharge stop switch 38 is connected to the Xe-lamp 21 in series. Discharge of the Xe-lamp 21 is compulsorily stopped by actuating the discharge stop switch 38. An input terminal of the timer circuit 36 is connected to the CPU 30 and the trigger circuit 35. An output terminal of the timer circuit 36 is connected to the discharge stop switch 38. The timer circuit 36 is activated in association with the discharge commencement of the Xe-lamp 21 (generation of the trigger signal) to measure a discharge time of the Xe-lamp 21.

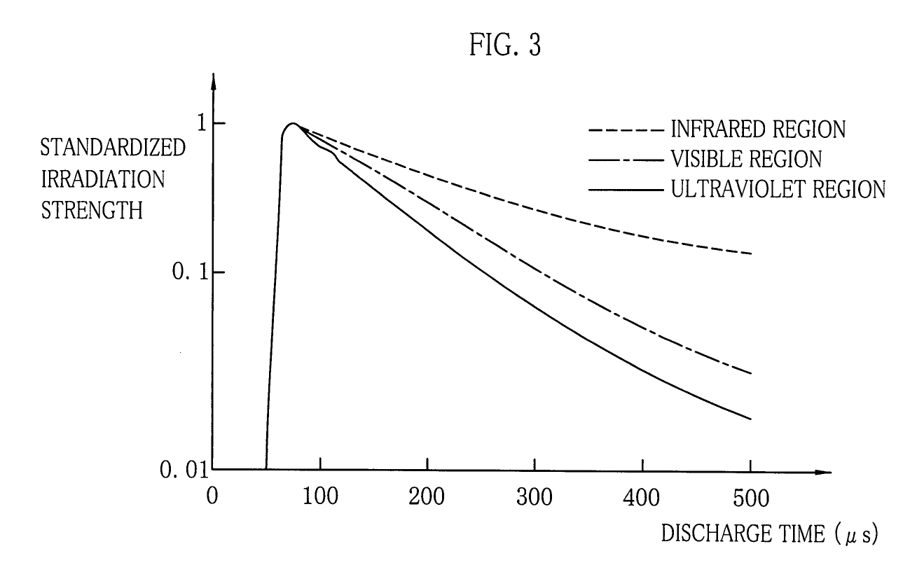

FIG. 3 shows a relationship between the discharge times of the Xe-lamp 21 and irradiation strengths thereof, with respect to each wavelength region. Evidently from this drawing, as to the irradiation strength of the Xe-lamp 21 relative to the discharge time, attenuation thereof concerning the short-wavelength region, especially concerning an ultraviolet region available for the optical fixation, becomes greater with the passage of the discharge time in comparison with the other regions. In view of this, the timer circuit 36 is operated at predetermined timing to stop the discharge of the Xe-lamp 21 via the discharge stop switch 38. By doing so, it is prevented to waste the energy of the infrared region, which is unavailable for the optical fixation. Further, the inside of the printer is prevented from becoming a high temperature due to the ingredient of the infrared region. It is possible to improve the efficiency of the optical fixation. Incidentally, the operation timing of the timer circuit 36 is determined so as to be an optimum value derived from various parameters of the Xe-lamp 21, for instance, from electric power to be supplied, fixation ability and a heating amount.

Next, an operation of the above embodiment is described below. Upon instruction of printing, the recording paper 10 is fed by the feed roller 12 and is conveyed by the conveyance roller pair 13 in the fixing direction A. Successively, the recording paper 10 is conveyed in the printing direction B by reversing the conveyance roller pair 13. During this conveyance, the yellow image is thermally recorded on the yellow thermosensitive coloring layer with the thermal head 18.

After thermally recording the yellow image, the recording paper 10 is conveyed in the fixing direction A. The short-wave cutting filter 23 is moved to the insertion position, and at the same time, the Xe-lamp 21 is turned on to radiate the near ultraviolet rays having a luminous peak of about 420 nm. The radiated ultraviolet rays are applied to the recording paper 10 to perform the optical fixation for the yellow thermosensitive coloring layer. At this time, the discharge stop switch 38 is actuated by the timer circuit 36 to compulsorily stop the discharge of the Xe-lamp 21. In virtue of this, it is prevented to waste the energy of the infrared region, which is unavailable for the optical fixation.

After conveying the recording paper 10 in the fixing direction A again, the recording paper 10 is conveyed in the printing direction B. During this conveyance, the magenta image is thermally recorded on the magenta thermosensitive coloring layer with the thermal head 18. Just after recording the magenta image, the short-wave cutting filter 23 is moved to the evacuation position, and at the same time, the Xe-lamp is turned on. The ultraviolet rays having a luminous peak of about 365 nm are applied to the recording paper 10 to perform the optical fixation for the magenta thermosensitive coloring layer. Also in this case, the discharge stop switch 38 is similarly actuated by the timer circuit 36 to compulsorily stop the discharge of the Xe-lamp 21.

Similarly to the above-mentioned process, the cyan image is thermally recorded on the cyan thermosensitive coloring layer. After thermally recording the cyan image, the recording paper 10 is conveyed in the fixing direction A by a predetermined amount to cut the recording area with the cutter 24. The recorded portion of the recording paper 10 is discharged from the paper outlet 25 and is stacked on a paper tray, which is not shown, in order.

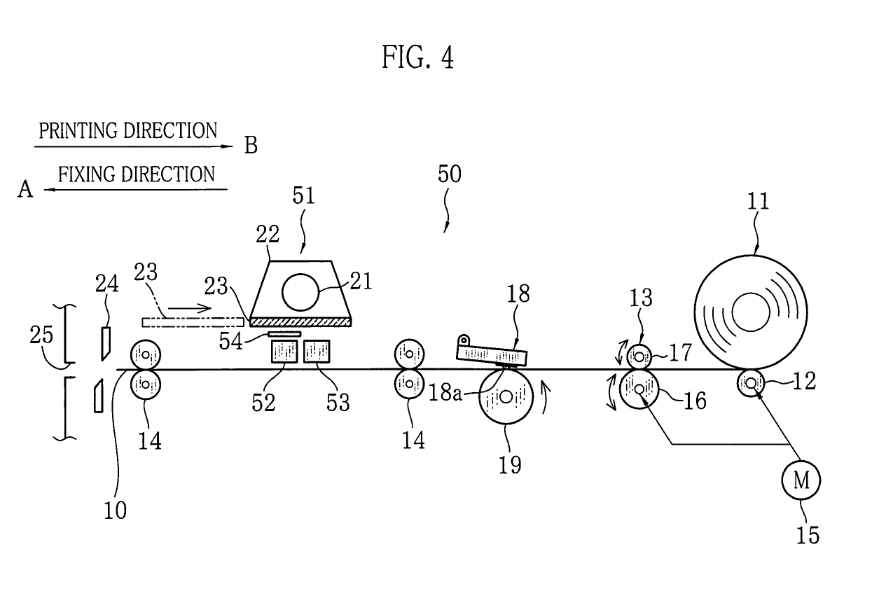

FIG. 4 shows a schematic structure of a color thermal printer 50 according to a second embodiment of the present invention. Under the Xe-lamp 21 of an optical fixing unit 51, are disposed a first illuminance sensor 52 and a second illuminance sensor 53. The first illuminance sensor 52 measures an irradiation amount of the infrared region, which is unavailable for the optical fixation. The second illuminance sensor 53 measures an irradiation amount of the whole wavelength regions. An infrared transmitting filter 54 is disposed above the first illuminance sensor 52. Incidentally, for instance, the illuminance sensors 52 and 53 employ a Si-photo diode having sensitivity for measuring wavelengths of 350 nm to 1000 nm. The illuminance sensors 52, 53 and the infrared transmitting filter 54 are disposed outside an optical-fixation area of the recording paper 10.

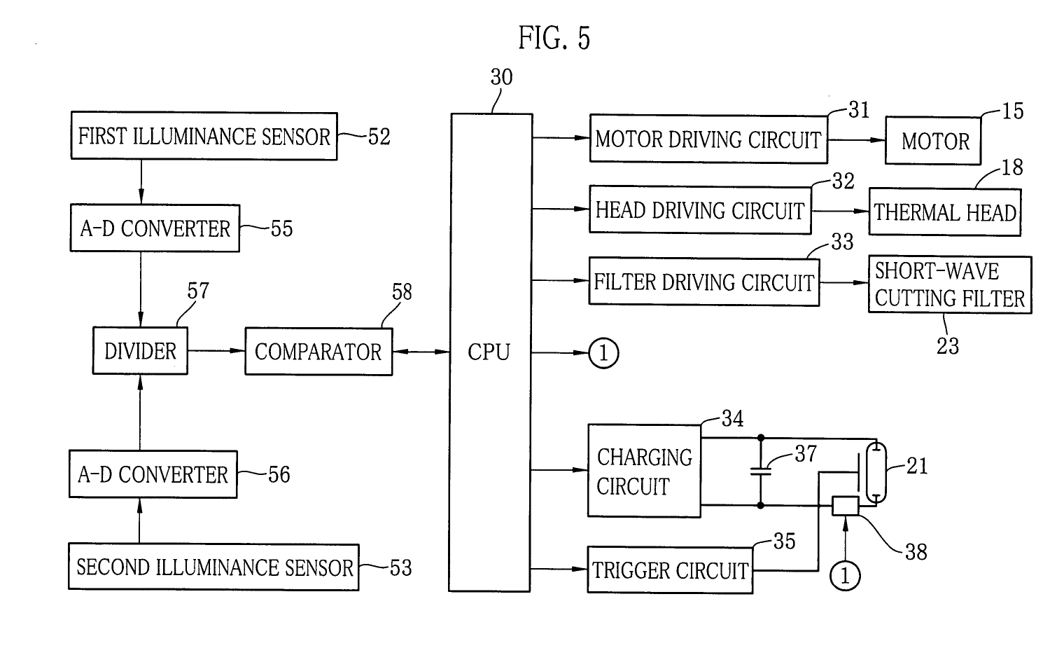

In FIG. 5 showing an electrical structure of the color thermal printer 50, the illuminance sensors 52 and 53 are connected to A-D converters 55 and 56 respectively. The A-D converters 55 and 56 convert measurement signals, which are outputted from the respective illuminance sensors 52 and 53, into digital signals. The converted digital signals are sent to a divider 57, which obtains a ratio of results measured by the respective illuminance sensors 52 and 53. In other words, the divider 57 obtains a ratio of a first irradiation amount to a second irradiation amount, wherein the first irradiation amount is measured relative to the whole wavelength regions and the second irradiation amount is measured relative to the infrared region. The ratio obtained by the divider 57 is sent to a comparator 58 in which the sent ratio is compared with a predetermined value set in advance. A comparison result is transferred to the CPU 30.

In the color thermal printer 50, the flash instruction signal is sent from the CPU 30 to the trigger circuit 35 to start the flash of the Xe-lamp 21. After that, the respective illuminance sensors 52 and 53 start the measurement. When the ratio of the results measured by the respective illuminance sensors 52 and 53 falls below the predetermined value, a stop signal is sent from the CPU 30 to actuate the discharge stop switch 38 so that the flash of the Xe-lamp is stopped. Incidentally, at the beginning of the flash of the Xe-lamp 21, it is likely to cause misjudegment due to measurement error of the illuminance sensor. For this reason, the judgement by the comparator 58 is performed while the irradiation strength is attenuated after reaching the maximum value, such as shown in FIG. 3. By the way, the above predetermined value is set so as to be an optimum value derived from various parameters of the Xe-lamp 21, similarly to the first embodiment.

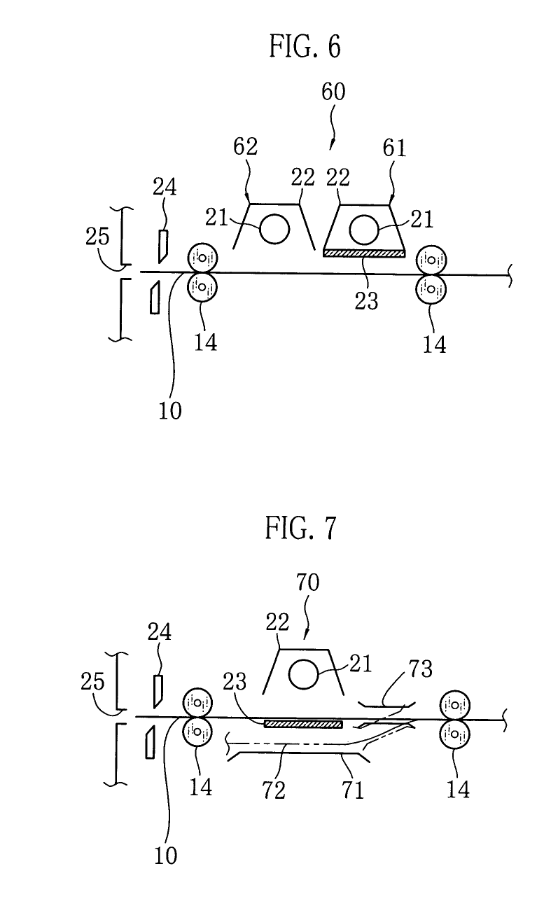

The optical fixing unit may have structures shown in FIGS. 6 and 7. An optical fixing unit 60 shown in FIG. 6 comprises a yellow fixing component 61 and a magenta fixing component 62. The short-wave cutting filter 23 is disposed only between the yellow fixing component 61 and the recording paper 10. In this case, since the short-wave cutting filter 23 is fixed, it is unnecessary to provide a filter driving circuit.

In an optical fixing unit 70 shown in FIG. 7, the short-wave cutting filter 23 is fixed to a lower side of the conveyance passageway of the recording paper 10. Under the short-wave cutting filter 23, is provided a yellow fixing passageway 72 formed by a guide plate 71. Moreover, a parting guide 73 is arranged at an upstream side of the optical fixing unit 70 in the fixing direction A. The parting guide 73 is rotatable between a first position shown by a solid line, where the recording paper 10 is normally conveyed, and a second position shown by a two-dot line, where the recording paper 10 is conveyed to the yellow fixing passageway. When the yellow image is fixed, the parting guide 73 is rotated to the second position shown by the two-dot line so that the recording paper 10 is conveyed to the yellow fixing passageway to apply the ultraviolet rays having passed through the short-wave cutting filter 23. Incidentally, omitted portions which are not shown in FIGS. 4 to 7 are similar to the first embodiment so that description thereof is abbreviated. Further, with respect to the components denoted by the reference numerals identical with those of the color thermal printer 2 shown in FIG. 2, description thereof is also abbreviated.

The condition for actuating the discharge stop switch 38 is not exclusive to the above embodiment. The discharge stop switch 38 may be actuated:

(1) when a discharge current of the Xe-lamp 21 falls below a predetermined value set in advance;

(2) when a voltage between the terminals of the Xe-lamp 21 falls below a predetermined value set in advance;

(3) when the irradiation amount of the whole wavelength regions of the Xe-lamp 21 falls below a predetermined value set in advance;

(4) when the irradiation amount of the wavelength region of the Xe-lamp 21, which is available for the optical fixation, falls below a predetermined value set in advance;

(5) when a ratio of the irradiation amount of the available wavelength region of the Xe-lamp 21 to the irradiation amount of the unavailable region thereof falls below a predetermined value set in advance;

(6) when a ratio of the irradiation amount of the available wavelength region of the Xe-lamp 21 to the irradiation amount of the whole wavelength regions thereof falls below a predetermined value set in advance;

(7) when a discharge current of the Xe-lamp 21 falls below a product of a maximum current in flashing and a predetermined ratio set in advance;

(8) when a voltage between the terminals of the Xe-lamp 21 falls below a product of a maximum voltage in flashing and a predetermined ratio set in advance;

(9) when an irradiation amount of the whole wavelength regions of the Xe-lamp 21 falls below a product of a maximum irradiation amount of the whole wavelength regions in flashing and a predetermined ratio set in advance;

(10) when an irradiation amount of the available wavelength region of the Xe-lamp 21 falls below a product of a maximum irradiation amount of the available wavelength region in flashing and a predetermined ratio set in advance.

(1) to (4) and (7) to (10) may be embodied by modifying the control member actuating the discharge stop switch 38. As to (1) and (7), an ampere meter is used as the control member. As to (2) and (8), a voltmeter is used as the control member. As to (3), (4), (9) and (10), an illuminance sensor is used as the control member. Further, (5) and (6) may be easily embodied by selecting a combination of the illuminance sensors in accordance with a purpose.

The color thermal printers described in the above embodiments adopt a one-head three-pass system in which the images of three colors are recorded with the sole thermal head, reciprocating the recording paper. The present invention, however, may be adapted to a color thermal printer of a three-head one-pass system in which images of three colors are recorded with three thermal heads during one-time conveyance of the recording paper.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An optical fixing unit for performing optical fixation, just after printing, on a thermosensitive recording paper in which at least two thermosensitive coloring layers are formed on a base, said thermosensitive coloring layer except the lowermost layer being optically fixed by electromagnetic rays having particular wavelength regions, said optical fixing unit comprising:
at least one flash-discharge tube for generating said electromagnetic rays;
discharge stop means for compulsorily stopping discharge of said flash-discharge tube; and
control means for actuating said discharge stop means on the basis of irradiation conditions of said electromagnetic rays.

2. An optical fixing unit according to claim 1, wherein said flash-discharge tube is a xenon flash lamp in which xenon gas is filled in a transparent glass tube.

3. An optical fixing unit according to claim 1, wherein said discharge stop means is a discharge stop switch connected to said flash-discharge tube in series.

4. An optical fixing unit according to claim 1, wherein said control means includes a timer for measuring a discharge time of said flash-discharge tube, and actuates said discharge stop means when a predetermined discharge time has passed.

5. An optical fixing unit according to claim 4, further comprising:
a trigger circuit for starting the discharge of said flash-discharge tube, said timer commencing to measure said discharge time in response to a signal outputted from said trigger circuit.

6. An optical fixing unit according to claim 1, wherein said control means comprises:
a first illuminance sensor for measuring a first irradiation amount of the electromagnetic rays relative to a wavelength region unavailable for the optical fixation;
a second illuminance sensor for measuring a second irradiation amount of the electromagnetic rays relative to the whole wavelength regions;
a division means for obtaining a ratio of said first and second irradiation amounts; and
a comparator for comparing the ratio obtained by said division means with a predetermined value set in advance.

7. An optical fixing unit according to claim 6, wherein said first and second illuminance sensors are disposed between said flash-discharge tube and said thermosensitive recording paper.

8. An optical fixing unit according to claim 7, wherein a filter for transmitting infrared rays is disposed between said first illuminance sensor and said flash-discharge tube, and said first illuminance sensor measures said first irradiation amount via said filter.

9. An optical fixing unit according to claim 8, wherein said first and second illuminance sensors and said filter are disposed outside an optical fixation area of said thermosensitive recording paper.

10. An optical fixing unit according to claim 1, wherein said at least two thermosensitive coloring layers are yellow, magenta and cyan thermosensitive coloring layers,
further including a short-wave cutting filter which removes the wavelength region fixing the magenta thermosensitive coloring layer, said cutting filter being inserted between said flash-discharge tube and said thermosensitive recording paper when optically fixing the yellow thermosensitive coloring layer, and said cutting filter being evacuated from an interval of said flash-discharge tube and said thermosensitive recording paper when optically fixing the magenta thermosensitive coloring layer.

11. An optical fixing unit according to claim 10, wherein said short-wave cutting filter is disposed under a conveyance passageway for conveying the thermosensitive recording paper, and the thermosensitive recording paper passes under the short-wave cutting filter when the yellow thermosensitive coloring layer is fixed.

12. An optical fixing unit according to claim 11, further comprising:
a parting guide disposed on the conveyance passageway of the thermosensitive recording paper, said parting guide guiding the thermosensitive recording paper to an under side of said short-wave cutting filter.

13. An optical fixing unit according to claim 12, wherein said parting guide is rotatable and rotates to guide the thermosensitive recording paper toward the under side of said short-wave cutting filter when the yellow thermosensitive coloring layer is fixed.

14. An optical fixing unit according to claim 1, wherein said at least two thermosensitive coloring layers include cyan, magenta and yellow thermosensitive coloring layers, and said at least one flash-discharge tube includes yellow and magenta flash-discharge tubes independently emitting the light, further comprising a short-wave cutting filter which removes the wavelength region fixing the magenta thermosensitive coloring layer, said short-wave cutting filter being disposed between said yellow flash-discharge tube and said thermosensitive recording paper.
